(19) United States
(12) Patent Application Publication
(10) Pub. No.: US 2026/0301582 A1
(43) Pub. Date: Oct. 1, 2026

(54) Radio Network Node, User Equipment and Methods Performed Therein

(71) Applicant: Telefonaktiebolaget LM Ericsson (publ), Stockholm (SE)

(72) Inventors: Helka-Liina Määttänen, Espoo (FI); Santhan Thangarasa, Vällingby (SE); Hieu Do, Järfälla (SE); Muhammad Ali Kazmi, Sundbyberg (SE)

(21) Appl. No.: 19/474,762

(22) PCT Filed: Oct. 18, 2023
(86) PCT No.: PCT/SE2023/051029

§ 371 Date: Oct. 13, 2025

Related U.S. Application Data
(60) Provisional application No. 63/496,426, filed on Apr. 17, 2023.

(51) Int. Cl. G08G 5/34; G08G 5/26; G08G 5/56; G08G 5/57; H04W 76/27

(52) U.S. Cl. CPC G08G 5/34; G08G 5/26; G08G 5/56; G08G 5/57; H04W 76/27

(57) ABSTRACT

Embodiments herein relate to, for example, a method performed by a UE (10) for handling communication in a wireless communications network. The UE transmits, in a low activity RRC state, a flight indication to a radio network node (120) using an SDT procedure, wherein the flight indication comprises one or more of the following: —at least a part of a flight path report; —an update to a flight path report, or an element of the flight path report; —an indication of availability of flight path report; —an indication of update on flight path report or part of it.

### TECHNICAL FIELD

Embodiments herein relate to a radio network node, a user equipment (UE) and methods performed therein regarding wireless communication. Furthermore, a computer program and a computer readable storage medium are also provided herein. In particular, embodiments herein relate to handling communication in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node e.g., a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate e.g., enhanced data rate and radio capacity. In some RANs, e.g., as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies such as NR, the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

In NR, which is based on Orthogonal Frequency-Division Multiplexing (OFDM), multiple numerologies are supported for operation, e.g., transmission and/or reception of signals. The term numerology may characterize any one or more of: frame duration, subframe or Transmission Time Interval (TTI) duration, slot duration, min-slot duration, symbol durations subcarrier spacing, number of Resource Blocks (RBs) within the bandwidth, number of subcarriers per physical channel, e.g., per RB, Cyclic Prefix (CP) length, e.g., normal and extended CP lengths, etc. A scaling approach, based on a scaling factor 2^{N}, N=1, 2, . . . , is considered for deriving subcarrier spacings for NR: 15 kHz, 30 kHz, 60 kHz, 120 kHz, 240 kHz etc. The numerology-specific time resource durations, e.g., slot, subframe etc, can then be determined based on the subcarrier spacing: subcarrier spacing of (2^{N}*15) kHz corresponds to a symbol duration of 1/(15000*2^{N}) second.

Furthermore, NR supports large number of bandwidths, which depends on the frequency range of signals transmitted in the cell. Examples of frequency ranges are frequency range 1 (FR1) and frequency range 2 (FR2). In FR1 the frequencies are lower than the frequencies belonging to FR2. An example of FR1 comprises a range of frequencies up to 7 GHz. An example of FR2 comprises a range of frequencies between 24 and 52.6 GHz. In FR1, examples of supported bandwidths are 5 MHz, 10 MHz, 20 MHz, 30 MHz, 40 MHz, 50 MHz, 80 MHz, 100 MHz etc. In FR2, examples of supported bandwidths are 50 MHz, 100 MHz, 200 MHz, 400 MHz etc.

The world is witnessing a widespread and increasing use of aerial UEs, or more technically the Unmanned Aerial Vehicles (UAV), in many segments of the economy and in our daily life. There are numerous use cases of UAVs in industry, goods transportation and delivery, surveillance, media production, etc.

Traditionally, the UAVs can only be flown by a controller within the Visual Line of Sight (VLoS). Realizing the great potential of connecting UAVs Beyond Visual Line of Sight (BVLoS) via cellular network, 3GPP have specified multiple features in LTE Rel-15, aiming at improving the efficiency and robustness of the terrestrial LTE network for providing aerial connectivity services, particularly for low altitude UAVs, i.e., UAV below a certain height threshold. These features target both command-and-control traffic for flying the drone and the data, also known as payload, traffic from the drone to the cellular network. The key features specified include:
Support for subscription-based identification
Height reporting when UAV crosses height threshold. The report includes height, location (3D), horizontal and vertical speed.
Reference Signal Received Power (RSRP) reporting per event of N cells' signal power above a threshold. The report includes RSRP, Reference Signal Received Quality (RSRQ) and/or location (3D).
UE-specific UL power control.
Flight path information provided from UE to eNB. This includes network polling and list of waypoints, such as 3D location, and time stamp if available.

These features were introduced targeting special needs when serving the UAVs by LTE network, e.g., the need for flying mode detection, interference detection, and interference mitigation. The first important issue was the flying mode detection, which is also related to interference detection as the interference conditions for flying aerial UEs are different from aerial UE in terrestrial mode. For interference detection, which may also serve as input to flying mode detection, an enhancement to existing events triggering of RSRP/RSRQ/Reference Signal (RS)-Signal to Interference plus Noise Ratio (SINR) reports was introduced in LTE Rel-15. The UE may be configured to trigger an event such as A3, A4, A5, which all consider neighbour cell measurements. In such event triggers, a measurement report is triggered when multiple cells' measured RSRPs (RSRQs/RS-SINRs) are above a threshold.

Another input to flying mode detection is event triggered height and location reporting. A new configurable event within Radio Resource Management (RRM) with height threshold is introduced for Rel-15 aerial UEs. When the UE is configured with an event, a report is triggered when UE's altitude crosses the threshold altitude. In addition to flying mode detection, the exact height information is considered useful as the network may choose to reconfigure, for example, measurement reporting configurations for the UE when it crosses a height threshold. FIG. 1 depicts this situation. In this figure, when the UE is below a height of 100m, the aerial UE is Radio Resource Control (RRC) configured with measurement reporting configurations and event triggered height/location reporting corresponding to a height threshold of 200m. As the aerial UE crosses a height threshold of 200m, a report is triggered from the UE to the network. After receiving the report from the aerial UE, the network RRC reconfigures the aerial UE with new measurement reporting configurations. FIG. 1 shows E-UTRAN reconfigures aerial UE based on flying altitude.

5.2.2 Decentralized UAS traffic management

[R-5.2.2-001] The 3GPP system shall enable a UAV to broadcast the following data for identifying
UAV(s) in a short-range area for collision avoidance: e.g., UAV identities if needed based on different
regulation requirements, UAV type, current location and time, flight route information, current speed,
operating status.
[R-5.2.2-002] The 3GPP system shall be able to support a UAV to transmit a message via network
connection for identifying itself as a UAV to the other UAV(s).
[R-5.2.2-003] The 3GPP system shall enable UAV to preserve the privacy of the owner of the UAV, UAV
pilot, and the UAV operator in its broadcast of identity information.
[R-5.2.2-004] The 3GPP system shall enable a UAV to receive local broadcast communication transport
service from other UAV in short range.
[R-5.2.2-005] A UAV shall be able to use a direct UAV to UAV local broadcast communication transport
service in the coverage or out of coverage of a 3GPP network.
[R-5.2.2-006] A UAV shall be able to use a direct UAV to UAV local broadcast communication transport
service when the sending and receiving UAVs are served by the same or different Public Land Mobile
Network (PLMNs).
[R-5.2.2-007] The 3GPP system shall support a direct UAV to UAV local broadcast communication
transport service at relative speeds of up to 320 kmph.
[R-5.2.2-008] The 3GPP system shall support a direct UAV to UAV local broadcast communication
transport service with variable message payloads of 50-1500 bytes, not including security-related message
component(s).
[R-5.2.2-009] The 3GPP system shall support a direct UAV to UAV local broadcast communication
transport service which supports a range of up to 600 m.
[R-5.2.2-010] The 3GPP system shall support a direct UAV to UAV local broadcast communication
transport service which can transmit messages at a frequency of at least 10 messages per second.
[R-5.2.2-011] The 3GPP system shall support a direct UAV to UAV local broadcast communication
transport service which can transmit messages with an end-to-end latency of at most 100 ms.

It is utmost important to keep the airspace safe and accessible. Therefore, a system called Unmanned Aircraft Systems (UAS) Traffic Management (UTM) is being developed in different parts of the world to manage the traffic of the UAS. A UAS comprises a UAV and a UAV controller used by an operator with unique credentials and identities. According to NASA, UTM is a collaborative, automated, and federated airspace management approach that enables safe, efficient, and equitable small UAS operations at scale. The concept of UTM is being adopted and implemented by many countries and regions in the world, e.g., in the US, Europe, Japan, Australia, etc.

According to reference TS 122 125 v.17.6.0, the UTM provides many flight-related functions for UAVs and UAV operators, for example:
Remote identification: enabling UAV identification.
Operation planning: flight planning considering various aspects e.g., UAV performance, weather condition.
Operator messaging: message exchange between operators for e.g., position and status information.
Federal Aviation Administration (FAA) messaging: providing on-demand, periodic, or event-triggered communications with FAA systems to meet regulatory requirements.
Mapping: information about airspace restrictions, obstacles, and sensitive regions.
Conflict advisory: real-time alerting for collision avoidance.

Mobile networks can enable reliable connectivity between the UAV and its controller. Meanwhile, UTM can connect to the UAV and the UAV controller through the CN and the RAN. An illustration of UAS-to-UTM connectivity is provided in FIG. 2, see TS 122 125 v. 17.6.0. FIG. 2 shows an example of UAS to UTM connectivity.

3GPP status of flight path reporting for UAVs.

It has been agreed:

Agreements:
1. A waypoint is a planned location for the UE along the flight path and is described via the existing parameter type LocationCoordinates defined in TS 37.355 v. 17.3.0.
2. A timestamp provides the UTC time associated with estimated time of arrival to a waypoint as baseline. It is For Further Study (FFS) on granularity.
3. No requirements are placed on spatial distribution of waypoints
4. A UE indicates whether flight plan information is available within the RRCReconfigurationComplete, RRCReestablishmentComplete, RRCResumeComplete, or RRCSetupComplete message. Flight path reporting uses at the UE, information request/response procedure as baseline.
5. UE indicates to the network that a new flight path is available in the UE, whether it is initial or update. Then, reuse the normal request/response procedure of flight path report.
6. UE Assistance Information (UAI) message can also be used to indicate that the UE has flight path availability.
7. It is FFS whether and what triggering conditions are specified for flight update. The maximum number of waypoints within flight path plan is left FFS.

### SUMMARY

As part of developing embodiments herein one or more problems were first identified.

The UAV flight path reporting works in a network-polling manner. That is, once the UE has been in RRC-connected mode, a network node will request the UE to report its flight path. This could be an initial report or report of an updated flight path. However, in some cases, it is desirable for the network to know the flight path of the UE immediately when the UE connects to the network so that the network can proactively take measures to ensure a good connectivity for the UAV during its flight. For example, knowing early that the UE will fly into a no-transmit zone for certain carrier frequency, the network can prepare for an early Hand-Over (HO) of the UE to another cell operating in a frequency allowed in that zone.

An object herein is to provide a mechanism to handle communication of a UE in flight in an efficient manner in the wireless communications network.

According to an aspect the object is achieved, according to embodiments herein, by providing a method performed by a UE for handling communication in a wireless communications network. The UE transmits, in a low activity RRC state, a flight indication to a radio network node using a small data transmission (SDT) procedure. The flight indication comprises one or more of the following: at least a part of a flight path report; an update to a flight path report, or an element of the flight path report; an indication of availability of flight path report; and/or an indication of update on flight path report or part of it. Thus, the flight indication may comprise one or more of: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it, wherein the indication indicates a flight path. A waypoint includes or consists of location coordinates, e.g., n-dimensional geographical coordinates, where n≥1, for an Aerial UE (AUE), such as a UAV, during the aerial operation of the AUE. The waypoints describe planned or expected locations for the UE during the flight path. Therefore, the flight path of the UE consists of one or more waypoints.

According to another aspect the object is achieved, according to embodiments herein, by providing a method performed by a radio network node for handling communication of a UE in a wireless communications network. The radio network node receives a flight indication from a UE, in a low activity RRC state, using an SDT procedure The flight indication comprises one or more of the following: at least a part of a flight path report; an update to a flight path report, or an element of the flight path report; an indication of availability of flight path report; and/or an indication of update on flight path report or part of it. Thus, the flight indication may comprise one or more of: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it, wherein the indication indicates a flight path.

The radio network node performs an action taking the flight indication into account.

According to aspects the object is achieved, according to embodiments herein, by providing a UE and a radio network node configured to perform the methods herein, respectively.

According to yet another aspect the object is achieved, according to embodiments herein, by providing a UE for handling communication in a wireless communications network. The UE is configured to transmit, in a low activity RRC state, a flight indication to a radio network node using a SDT procedure. The flight indication comprises one or more of the following: at least a part of a flight path report; an update to a flight path report, or an element of the flight path report; an indication of availability of flight path report; and/or an indication of update on flight path report or part of it.

According to still another aspect the object is achieved, according to embodiments herein, by providing a radio network node for handling communication of a UE in a wireless communications network. The radio network node is configured to receive, in a low activity RRC state, a flight indication from a UE using an SDT procedure The flight indication comprises one or more of the following: at least a part of a flight path report; an update to a flight path report, or an element of the flight path report; an indication of availability of flight path report; and/or an indication of update on flight path report or part of it. The radio network node is further configured to perform an action taking the flight indication into account.

It is furthermore provided herein a computer program product comprising instructions, which, when executed on at least one processor, cause the at least one processor to carry out the methods herein, as performed by the UE or the radio network node, respectively. It is additionally provided herein a computer-readable storage medium, having stored thereon a computer program product comprising instructions which, when executed on at least one processor, cause the at least one processor to carry out any of the methods herein, as performed by the UE or the radio network node, respectively.

The embodiments herein cover different solutions for how availability of UE flight path may be indicated via SDT procedure. It is also given details on reporting the flight path itself via SDT. In addition, other additional details on flight path reporting initiation are also disclosed. Embodiments herein disclose one or more ways to inform the radio network node about flight path update or availability earlier than with the different RRC complete messages. Thus, embodiments herein handle communication of a UE, for example, in flight, in the wireless communications network in an efficient manner.

### BRIEF DESCRIPTION OF THE DRAWINGS

Embodiments will now be described in more detail in relation to the enclosed drawings, in which:

FIG. 1 shows a scenario according to prior art;

FIG. 2 shows an architecture according to prior art;

FIG. 3 shows an overview depicting a wireless communications network according to embodiments herein;

FIG. 4 shows a combined flowchart and signalling scheme according to embodiments herein;

FIG. 5 shows a flowchart depicting a method performed by a UE according to embodiments herein;

FIG. 6 shows a flowchart depicting a method performed by a radio network node according to embodiments herein;

FIG. 7 shows a block diagram depicting embodiments of a UE according to embodiments herein;

FIG. 8 shows a block diagram depicting embodiments of a radio network node according to embodiments herein;

FIG. 9 schematically illustrates a telecommunication network connected via an intermediate network to a host computer;

FIG. 10 is a generalized block diagram of a host computer communicating via a base station with a user equipment over a partially wireless connection; and

FIGS. 11, 12, 13, and 14 are flowcharts illustrating methods implemented in a communication system including a host computer, a base station and a user equipment.

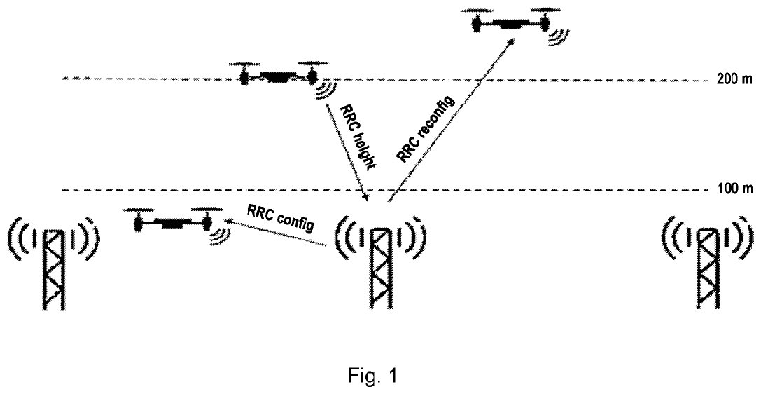

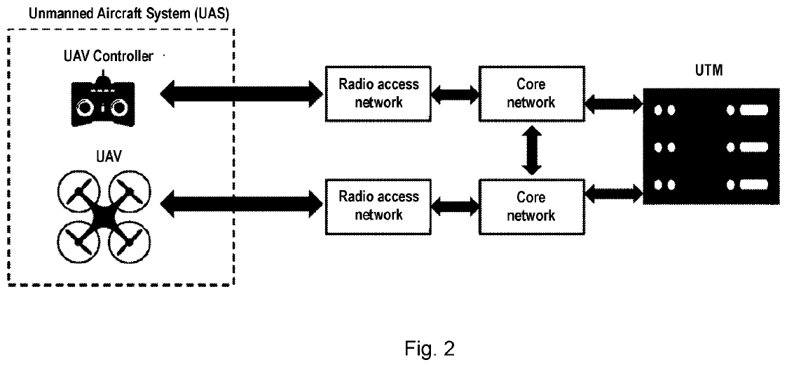

### DETAILED DESCRIPTION

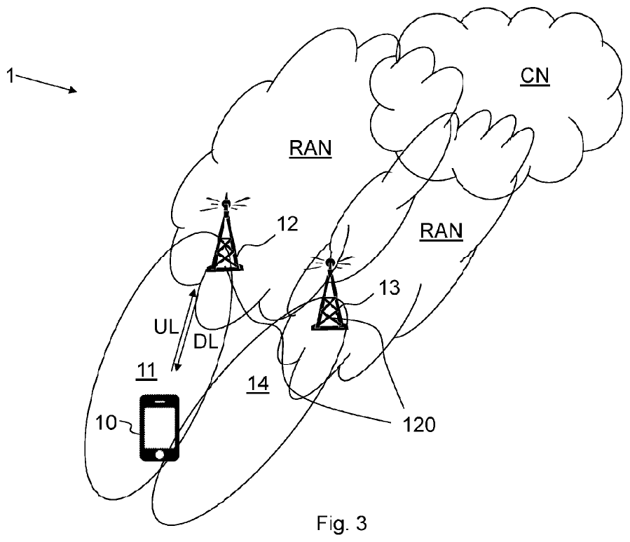

Embodiments herein relate to wireless communications networks in general. FIG. 3 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in an NR context, however, embodiments are also applicable in further development of existing wireless communications systems such as e.g., LTE or WCDMA.

In the wireless communications network 1, a User Equipment (UE) 10 exemplified herein as a wireless device such as an aerial UE, a UAV, aerial vehicle, a mobile station, a non-access point (non-AP) station (STA), a STA and/or a wireless terminal, is comprised communicating via e.g., one or more Access Networks (AN), e.g., RAN, to one or more CNs. It should be understood by the skilled in the art that “UE” is a non-limiting term which means any terminal, wireless communications terminal, user equipment, NarrowBand Internet of Things (NB-IoT) device, Machine Type Communication (MTC) device, Device to Device (D2D) terminal, or node e.g., smart phone, laptop, mobile phone, sensor, relay, mobile tablets or even a small base station capable of communicating using radio communication with a radio network node within an area served by the radio network node.

The wireless communications network 1 comprises a first radio network node 12, also referred to as the radio network node, providing radio coverage over a geographical area, a first service area 11 or first cell, of a first Radio Access Technology (RAT), such as NR, LTE, or similar. The first radio network node 12 may be a transmission and reception point such as an access node, an access controller, a base station, e.g., a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the first radio network node 12 depending e.g., on the first radio access technology and terminology used. The first radio network node 12 may be referred to as a NG-RAN node, serving radio network node wherein the service area may be referred to as a serving cell, and the serving network node communicates with the wireless device in form of DL transmissions to the wireless device and UL transmissions from the wireless device. It should be noted that a service area may be denoted as cell, beam, beam group or similar to define an area of radio coverage. The first cell may be referred to as serving or source cell.

The wireless communications network 1 comprises a second radio network node 13 providing radio coverage over a geographical area, a second service area 14 or second cell, of a second RAT, such as NR, LTE, or similar. The second radio network node 13 may be a transmission and reception point such as an access node, an access controller, a base station, e.g., a radio base station such as a gNodeB (gNB), an eNB, eNode B), a NodeB, a base transceiver station, a radio remote unit, an Access Point Base Station, a base station router, a WLAN access point or an AP STA, a transmission arrangement of a radio base station, a stand-alone access point or any other network unit or node capable of communicating with a wireless device within the area served by the radio network node depending e.g., on the second radio access technology and terminology used. The second cell may be referred to as candidate or target cell.

According to embodiments herein a radio network node 120 receives a flight indication from the UE 10. The radio network node 120 may comprise the first radio network node 12 or the second radio network node 13.

Small data transmission (SDT) is a procedure to transmit UL data from the UE 10 in RRC_INACTIVE state introduced in Rel-17. The Idea is that small amount of data can be transmitted while the UE 10 remains in RRC-INACTIVE. SDT is performed with either random access, either 4-step Random Access (RA) type and 2-step RA type, or with Configured Grant (CG). If the UE 10 uses a 4-step RA type for SDT procedure, then the UE 10 transmits the UL data in the Msg3. If the UE 10 uses a 2-step RA type for SDT procedure, then the UE 10 transmits UL data in the MSGA. The CG can be used if the UE 10 has valid UL time alignment and if not then RA.

Two types of CG UL transmission schemes have been supported in NR since Rel-15, referred as CG Type1 and CG Type2. The major difference between these is that for CG Type1, an uplink grant is provided by RRC configuration and activated automatically, while in the case of CG Type2, the uplink grant is provided and activated via L1 signalling, i.e., by an UL Downlink Control Information (DCI) with Cyclic Redundancy Check (CRC) scrambled by Configured Scheduling-Rradio Network Temporary Identifier (CS-RNTI). In both cases, the spatial relation used for Physical Uplink Shared Channel (PUSCH) transmission with CG is indicated by the uplink grant, either provided by the RRC configuration or by an UL DCI.

At the end of RA procedure, the UE 10 triggers a transmission to the network on Signalling Radio Bearer 1 (SRB1) wherein an RRC message indicates the availability of data in the buffer of SRB(s) and/or Data Radio Bearer(s) (DRB) not configured for SDT. The RRC message is transmitted as SDT data in the SDT procedure. Based on the RRC message, the Network (NW) may bring the UE into CONNECTED mode with RRCResume response, or alternatively to IDLE mode using a RRCRelease including a suspendConfig.

Embodiments herein relate to how availability of UAV flight path may be indicated via an SDT procedure by the UE 10, such as an Aerial UE (AUE), also called as UAV, to the radio network node 120, e.g., to a serving base station. Details on reporting the flight path itself via SDT to the radio network node 120 are also given.

In addition, other additional details on triggers of a flight path reporting initiation are herein disclosed. The UE 10 may select or determine one of the pluralities of the SDT methods based on one or more criteria related to one or more UAV flight path characteristics, e.g., UAV height, mobility state, criticality of the situation, radio emission requirements etc, and uses the selected SDT method for transmitting information about the UAV's flight path to the radio network node 120. Embodiments herein further disclose one or more ways to inform network about flight path update or availability earlier than the different RRC complete messages.

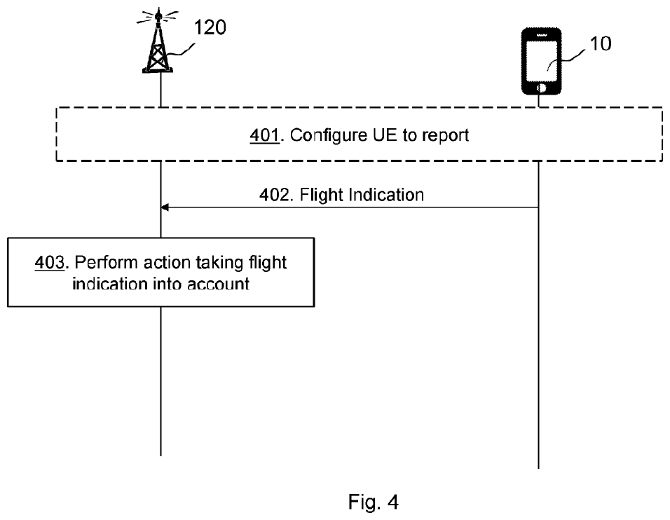

A combined flowchart and signalling scheme according to embodiments herein will now be described with reference to a flowchart depicted in FIG. 4. The actions do not have to be taken in the order stated below, but may be taken in any suitable order. Actions performed in some embodiments are marked with dashed boxes.

Action 401. The radio network node 120 may configure the UE 10 to perform the procedure, i.e., report flight indication(s) using or during SDT.

The UE 10 may be configured to transmit information about the flight path, i.e., the flight indication, when one or more conditions are met, e.g., when the flight path changes with regards to a planned or pre-configured flight path.

Action 402. The UE 10 transmits, in a low activity RRC state, a flight indication to the radio network node using an SDT procedure. The flight indication comprises one or more of the following: at least a part of a flight path report; an update to a flight path report, or an element of the flight path report; an indication of availability of flight path report; and/or an indication of update on flight path report or part of it. Or in other words the flight indication may comprise Flight Path Information (FPI). The FPI may comprise one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it.

Note that flight path or a flight path plan essentially means a mobility plan or route plan and may be indicating a route on the ground as well.

Action 403. The radio network node 120 performs an action taking the flight indication into account. For example, the flight indication or FPI may be an indication of availability of flight path plan, or it is indication of update availability for flight path plan. The radio network node 120 may respond to msg3 if the UE 10 is performing 4-step Random Access Channel (RACH), or transmit a response message to MSGA if the UE 10 is performing 2-step RACH whether network wants the UE 10 to report the flight indication. The radio network node 120 may then either wait for scheduling request from the UE 10 or may directly schedule uplink resources for the flight path report.

The radio network node 120 may proactively take certain measures to ensure that the connectivity is ensured during the flight of the UAV.

The radio network node 120 may prepare network resources or mobility management measures to cope with interference and mobility challenges caused by high speed/altitude of the UAV.

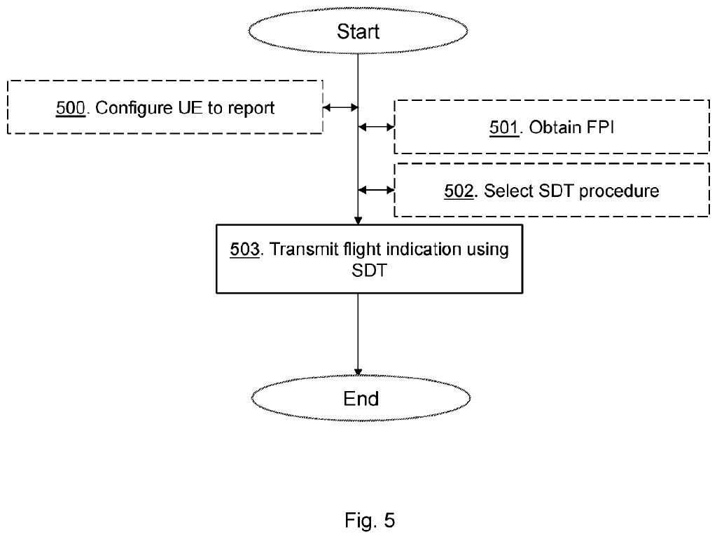

The method actions performed by the UE 10 for handling communication in the wireless communications network, for example, handling flight information, according to embodiments herein will now be described with reference to a flowchart depicted in FIG. 5. The actions do not have to be taken in the order stated below, but may be taken in any suitable order. Actions performed in some embodiments are marked with dashed boxes.

Action 500. The UE 10 may be configured by the radio network node 120, to perform the procedure, i.e., report or transmit one or more flight indications using a SDT procedure. The UE 10 may be configured to transmit flight indication when one or more conditions are met, e.g., when the flight path changes with regards to the planned or pre-configured flight path.

Action 501. The UE 10 may obtain FPI. The UE 10 may receive FPI from an operator or similar. The FPI may comprise one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it.

Action 502. The UE 10 may select a SDT method among a plurality of SDT methods for transmitting the flight indication to the radio network node 120 based on one or more criteria. The one or more criteria may comprise one or more of the following:
based on a criticality of flight path characteristics;
to meet additional radio emission requirements during operation;
based on a timing relation between waypoints during a flight path;
based on a relation between number of waypoints and a threshold;
based on direction of movement of the UE;
based on a mobility state of the UE; and
based on a height and a threshold.

Action 503. The UE 10 transmits, in the low activity RRC state, the flight indication to the radio network node 120 using an SDT procedure. The flight indication comprises one or more of the following: at least a part of a flight path report; an update to a flight path report, or an element of the flight path report; an indication of availability of flight path report; and an indication of update on flight path report or part of it. Thus, the flight indication may comprise FPI, wherein the FPI comprises one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it.

The flight indication may be transmitted when one or more conditions are met. The one or more conditions may comprise one or more of the following: if no flight indication has been sent to a same radio network node in previous x seconds; if a current location of the UE or a next waypoint is within a position interval from a border of a geographical area; if a velocity and/or a height of the UE exceeds a certain pre-defined or pre-configured velocity and/or height threshold; when a number of waypoints during a flight or a time period exceeds a threshold; and based on a timing relation between waypoints. For example, the UE 10 may transmit the flight indication using the SDT procedure provided that the time period between any two successive waypoints in time during the flight exceeds certain threshold.

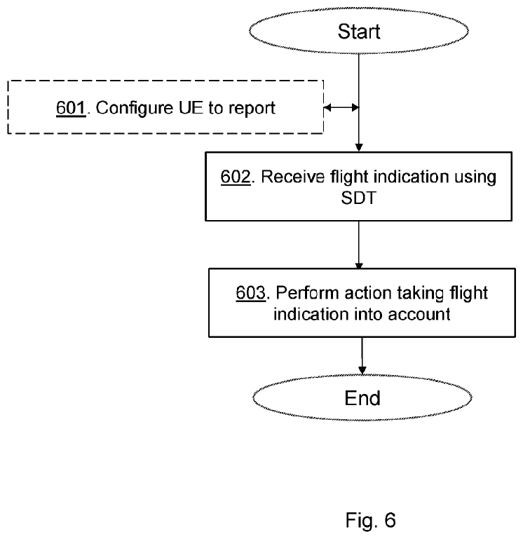

The method actions performed by the radio network node 120 for handling communication in the wireless communications network, for example, handling flight information, according to embodiments herein will now be described with reference to a flowchart depicted in FIG. 6. The actions do not have to be taken in the order stated below, but may be taken in any suitable order. Actions performed in some embodiments are marked with dashed boxes.

Action 601. The radio network node 120 may configure the UE 10 to perform the procedure, i.e., to transmit or report one or more flight indications using the SDT procedure. The UE 10 may be configured to transmit flight indication, which is information about the flight path, when one or more conditions are met, e.g., when the flight path changes with regards to the planned or pre-configured flight path. The one or more conditions may comprise one or more of the following: if no flight indication has been sent to a same radio network node in previous x seconds; if a current location of the UE or a next waypoint is within a position interval from a border of a geographical area; if a velocity and/or a height of the UE exceeds a certain pre-defined or pre-configured velocity and/or height threshold; when a number of waypoints during a flight or a time period exceeds a threshold; and/or based on a timing relation between waypoints.

Action 602. The radio network node 120 receives the flight indication from the UE 10, in the low activity RRC state, using the SDT procedure. The flight indication comprises one or more of the following: at least a part of a flight path report; an update to a flight path report, or an element of the flight path report; an indication of availability of flight path report; and an indication of update on flight path report or part of it. The flight indication may thus comprise FPI, wherein the FPI comprises one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it.

Action 603. The radio network node 120 performs an action taking the flight indication into account. For example, the flight indication may be an indication of availability of flight path plan, or it is indication of update availability for flight path plan. The radio network node 120 may respond to a msg3 if the UE 10 is performing 4-step RACH or in a response message to MSGA if the UE 10 is performing 2-step RACH whether the radio network node 120 wants the UE 10 to report the flight indication. The radio network node 120 may then either wait for a scheduling request from the UE or directly schedule one or more uplink resources for a flight path report.

The radio network node 120 may proactively take one or more measures to ensure that a connectivity is ensured during a flight of the UE.

The radio network node 120 may prepare network resources or mobility management measures to cope with interference and mobility challenges caused by high speed and/or altitude of the UE.

A scenario comprises the UE 10 served by a first cell 11, which is managed or served by the first radio network node 12. The terms UE, UAV, and AUE are interchangeably used and refer to any aerial device or equipment or object housing or containing the UE 10. Examples of aerial device or object are aircrafts, drones, flying objects as described herein. But the term UE used in any of the embodiments may also be referred to as AUE.

The UE 10 may be configured by serving network by receiving a message comprising different types of configurations for enabling the UE 10 to inform network about flight path update or availability. For example, the UE 10 may be configured by the first radio network node 12 to report flight indication such as flight path information to the first radio network node 12. For example, the UE 10 may be configured by the first radio network node 12 to transmit information about the flight path when one or more conditions are met e.g., when the flight path changes with regards to the planned or pre-configured flight path.

In some embodiments an aerial UE housing or a housing containing the UE, i.e., AUE, is flying from the first cell (cell1) to the second cell (cell2) which is managed or served by the first radio network node 12, e.g., NW1, or by the second radio network node 13, e.g., NW2. In some embodiments, NW1 and NW2 may be the same, e.g., served by same BS. In some embodiments, NW1 and NW2 are different. Cell1 and cell2 may operate on the same carrier frequency, e.g., F1, or on different carrier frequencies, e.g., cell1 and cell2 on first frequency F1 and second frequency F2, respectively.

The aerial UE 10 is operating in the low activity RRC state. Examples of the low activity RRC state are an RRC idle state, and an RRC inactive state.

In embodiments herein, the term flight indication or flight path information (FPI) may be used, which may be any of:
Flight path report, or part of flight path report.
Update to flight path report, or element of the flight path report
   For example, if flight path report consists of waypoints and time stamp, the element may be one of these or one coordinate used in waypoint expression
Indication of availability of flight path report
Indication of update on flight path report or part of it

It is herein disclosed a method in the UE 10 for indicating flight path update or availability, and/or sending the flight indication, see action 503 above.

The embodiments below can be combined in various meaningful ways.

If the UE 10 is capable of SDT, the UE 10 may include the flight indication or FPI in msg3 if the UE 10 is performing 4-step RACH or in MSGA if the UE 10 is performing 2-step RACH.

The flight indication or FPI sent in the SDT may comprise only up to N immediate waypoints, where N is a (pre-) configured parameter to ensure a small size of the flight indication or FPI.

The flight indication or FPI sent in the SDT may comprise only the waypoint of one or more emergency landing spots of the UE 10. This way, the most critical waypoints in the flight path are prioritized to be reported and the size of the report is kept small to fit the SDT.

The flight indication or FPI may be sent in the SDT if no flight indication or FPI has been sent to a same radio network node in previous x seconds, i.e., within an interval.

The flight indication or FPI may be sent in the SDT if the current location of the UE 10 or a next waypoint is in a vicinity of certain special geographical area known to the UE 10 such as a no-fly zone, a no-transmit zone, a restricted area, a disaster-struck area. That is, within a position interval from a border of said zone/area. This way, the network can proactively take certain measures to ensure that the connectivity is ensured during the flight of the UAV.

The flight indication or FPI may be sent in the SDT if a velocity and/or a height of the UAV exceeds a certain pre-defined or pre-configured velocity and/or height threshold. In this case, it is more critical for the network to prepare network resources or mobility management measures to cope with the interference and mobility challenges caused by high speed/altitude of the UAV. In an example, the flight indication or FPI may be sent in the SDT if the UAV has high vertical speed, above a speed threshold, e.g., in take off and landing, because in these phases, the UAV can cross many beams in a short period of time.

In a variant, an AUE specific transmission mode may be defined where the UE 10 may include the flight indication or FPI in msg3 if the UE 10 is performing 4-step RACH or in MSGA if the UE 10 is performing 2-step RACH.

If a new message is defined for aerial operation which may carry the flight indication or FPI, in a variant, it may carry also other aerial related indications. The UE 10 may be configured with a CG and send this message in the corresponding allocation.

The flight indication or FPI may be an indication of availability of flight path plan, or it is an indication of update availability for flight path plan. The radio network node 120 may respond to msg3 if the UE 10 is performing 4-step RACH or response message to MSGA if the UE 10 is performing 2-step RACH whether network wants the UE 10 to report the flight path plan. The radio network node 120 may then either wait for scheduling request from the UE 10 or directly schedule uplink resources for the flight path report.

In another aspect of the flight path reporting using SDT procedure, the UE 10 may transmit the flight indication using the SDT procedure to the radio network node based on a relation between the number of waypoints and a threshold. In one example, the UE 10 may transmit the flight indication using the SDT procedure provided that the number of waypoints during the flight exceeds certain threshold. In one example, the UE transmits the flight path reporting using the SDT procedure provided that the number of waypoints during certain time period within the flight exceeds certain threshold.

In another aspect of the flight path reporting using SDT procedure, the UE 10 may transmit the flight indication using the SDT procedure to the radio network node 120 based on a timing relation between the waypoints. In one example, the UE 10 may transmit the flight indication using the SDT procedure provided that the time period between any two successive waypoints in time during the flight exceeds certain threshold. In another example, the UE transmits the flight indication using the SDT procedure provided that the time period since the last waypoint within the flight exceeds certain threshold.

It is further herein disclosed a method in the UE 10, such as an AUE, for selecting between SDT mechanisms based on UE flight characteristics for indicating flight path update or availability, or sending the flight indication or flight path report, see action 502 above.

The embodiments herein can be combined in various meaningful ways.

In one embodiment the UE 10 selects or determines a SDT method among plurality of SDT methods for transmitting the information about the UE's flight path to a radio network node, e.g., NW1, based on one or more criteria related to the UE flight path characteristics. The UE 10 transmits the information about the UE's flight path using the selected SDT method to the radio network node 120. The contents of the flight path information transmitted by the UE 10 using the selected SDT method to the radio network node 120 can be the same as described in the preceding embodiments e.g., one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it, wherein the indication indicates a flight path. Furthermore, the flight indication, also referred to as flight path information, may also include a reason or criterion (as described below) used by the UE 10 for selecting the SDT method for transmitting the flight indication to the radio network node 120.

Examples of the SDT methods are CG-SDT based SDT transmission, CG based SDT transmission (CG-SDT), random access based SDT (RA-SDT) etc. Examples of the RA-SDT are 2-step RA based SDT (2-step-RA-SDT), 4-step RA based SDT (4-step-RA-SDT) etc.

Examples of the one or more criteria related to the UE's flight path characteristics that are used by the UE 10 for selecting or determining the SDT method for the UE's flight path information reporting are:
Height of the UE 10. The height may also be called as altitude or elevation. The height may be defined with regards to a reference level, which may be pre-defined or configured by the radio network node 120. Examples of the reference level are sea level, certain reference height, a threshold etc.
Mobility state of the UE 10. The mobility state of the UE 10 can be characterized by one or more mobility related parameters, e.g., speed of the UE 10, direction of the motion, acceleration of the UE 10, information related to the waypoints during the flight path of the UE 10 etc.
The UE 10 has experienced, e.g., during the last T1 seconds, or is experiencing a critical situation. The UE 10 enters or operates in a critical situation or state while it is experiencing or if it has recently experienced or encountered a critical situation. When the UE 10 is not experiencing or if it has not recently experienced or encountered a critical situation then the UE 10 reverts to the non-critical situation or state e.g., also called as a normal state of the UE operation. As an example, the UE 10 may be in a critical situation or state when one or more of the following conditions are met:
   Emergency landing,
   Malfunctioning of the UE 10 or one or more parts of the UE 10,
   Battery power or fuel level is or expected to be in critical situation or level. For example, the battery power or fuel level are in critical level when any one or more of the following conditions related to the battery power or fuel level are met:
      amount of the battery power is below certain threshold,”
      amount of the remaining battery power is below certain threshold,
      amount of the battery power consumed during the flight is above certain threshold,
      amount of the battery power expected to be consumed during the entire flight path will exceed certain threshold,
      amount of the battery power expected to be consumed during the remaining part of the flight path.
   UE 10 is unable to maintain the flight path e.g., due to storming weather or strong headwind etc.,
   UE 10 has collided with an object. The object can be an active object e.g., another AUE, a BS radio equipment etc., or a passive object e.g., tower, skyscraper etc.,
   UE 10 in close range with more than certain number of objects etc.,
   UE's flight path has changed with regards to a reference flight path. Examples of the reference flight path of the UE 10 are pre-configured flight path, initial flight path e.g., decided at the start of the flight, planned or usual flight path. If none of the above critical conditions is met, then the UE 10 is considered to be in non-critical or normal state.
Whether additional or Special Radio Emission (SRE) requirements, e.g., additional spurious emissions, additional Out Of Band Emission (OOBE) etc., are to be met by the UE 10 for transmission of the signals. The additional or special radio emission requirements may have to be met by the UE 10 when transmitting signal in certain region or location and/or in certain frequency range. Examples of the frequency ranges in which the UE 10 has to meet the additional radio emissions requirements are 1710-1785 MHz, 2500-2570 MHz, 2570-2620 MHz etc.

The method in the UE 10 of selecting or determining a SDT method based on the UE's flight path characteristics can be defined by one or more rules which can be pre-defined or configured by the radio network node 120. Examples of such rules are:
In one example of the rule, the UE 10 selects between the RA-SDT and CG-SDT based on the height of the UE 10 or based on a relation between the height of the UE 10 and certain threshold. Different rules may be applied depending on the purpose and scenario, e.g., based on the type of the UE's flight path information to be sent via SDT. This is explained with several examples below:
   In one example, the UE 10 selects the RA-SDT if the UE's height is below certain height threshold (H11); otherwise the UE 10 selects the CG-SDT.
   In another example, the UE 10 selects the CG-SDT if the UE's height is below certain height threshold (H12); otherwise the UE 10 selects the RA-SDT.
   In another example, the UE 10 selects the 2-step-RA-SDT if the UE's height is below certain height threshold (H13); otherwise the UE 10 selects the 4-step-RA-SDT.
   In another example, the UE 10 selects the 4-step-RA-SDT if the UE's height is below certain height threshold (H14); otherwise the UE selects the 2-step-RA-SDT.
In another example of the rule, the UE 10 selects between the RA-SDT and CG-SDT based on the mobility state of the UE 10, e.g., based on a relation between the speed of the UE 10 and certain threshold, based on the direction of the movement of the UE 10 with regards to the reference direction or location, number of waypoints, time between the waypoints etc. Different rules may also be applied depending on the purpose and scenario e.g., based on the type of the UE's flight path information to be sent via SDT. This is explained with several examples below:
   I. In one example, the UE 10 selects the RA-SDT if the UE's speed is below certain threshold (H21); otherwise the UE 10 selects the CG-SDT.
   II. In another example, the UE 10 selects the CG-SDT if the UE's speed is below certain height threshold (H22); otherwise the UE 10 selects the RA-SDT.
   III. In another example, the UE 10 selects the 2-step-RA-SDT if the UE's speed is below certain height threshold (H13); otherwise the UE 10 elects the 4-step-RA-SDT.
   IV. In another example, the UE 10 selects the 4-step-RA-SDT if the UE's speed is below certain height threshold (H14); otherwise the UE 10 selects the 2-step-RA-SDT.
   V. In another example, the UE 10 selects the RA-SDT if the UE 10 is descending or moving towards the ground level; otherwise, i.e., if the UE 10 is ascending or moving away from the ground level, the UE 10 selects the CG-SDT.
   VI. In another example, the UE 10 selects the CG-SDT if the UE 10 is descending or moving towards the ground level; otherwise, i.e., if the UE 10 is ascending or moving away from the ground level, the UE 10 selects the RA-SDT.
   VII. In another example, the UE 10 selects the 2-step-RA-SDT if the UE's is descending or moving towards the ground level; otherwise, i.e. if the UE 10 is ascending or moving away from the ground level, the UE 10 selects the 4-step-RA-SDT.
   VIII. In another example, the UE 10 selects the 4-step-RA-SDT if the UE 10 is descending or moving towards the ground level; otherwise i.e., if the UE 10 is ascending or moving away from the ground level, the UE 10 selects the 2-step-RA-SDT.
   IX. In another example, the UE 10 selects between the CG-SDT and the RA-SDT or selects between 2-step-RA-SDT and 4-step-RA-SDT for the flight path reporting using SDT procedure based on a relation between the number of waypoints and a threshold. This is described with examples below:
      a. In one example, the UE 10 selects the CG-SDT provided that the number of waypoints during the flight exceeds certain threshold. Otherwise, the UE 10 selects the RA-SDT.
      b. In another example, the UE 10 selects the CG-SDT provided that the number of waypoints within certain time period during the flight exceeds certain threshold. Otherwise, the UE 10 selects the RA-SDT.
      c. In another example, the UE 10 selects 4-step-RA-SDT provided that the number of waypoints during the flight exceeds certain threshold. Otherwise, the UE 10 selects the 2-step-RA-SDT.
      d. In another example, the UE 10 selects 4-step-RA-SDT provided that the number of waypoints within certain time period during the flight exceeds certain threshold. Otherwise, the UE 10 selects the 2-step-RA-SDT.
      e. In another example, the UE 10 selects 2-step-RA-SDT provided that the number of waypoints during the flight exceeds certain threshold. Otherwise, the UE 10 selects the 4-step-RA-SDT.
      f. In another example, the UE 10 selects 3-step-RA-SDT provided that the number of waypoints within certain time period during the flight exceeds certain threshold. Otherwise, the UE 10 selects the 4-step-RA-SDT.
      g. In another example, the UE 10 selects the RA-SDT provided that the number of waypoints during the flight exceeds certain threshold. Otherwise, the UE 10 selects the CG-SDT.
      h. In another example, the UE 10 selects the RA-SDT provided that the number of waypoints within certain time period during the flight exceeds certain threshold. Otherwise, the UE 10 selects the CG-SDT.
X. In another example, the UE 10 selects between the CG-SDT and the RA-SDT or selects between 2-step-RA-SDT and 4-step-RA-SDT for the flight path reporting using SDT procedure based on a timing relation between the waypoints during the flight path of the UE 10. This is described with examples below:
   a. In one example, the UE 10 selects the CG-SDT provided that the time period between any two successive waypoints during the flight exceeds certain threshold. Otherwise, the UE 10 selects the RA-SDT.
   b. In another example, the UE 10 selects the CG-SDT provided that the time period since the last waypoint during the flight exceeds certain threshold. Otherwise, the UE 10 selects the RA-SDT.
   c. In another example, the UE 10 selects 4-step-RA-SDT provided that the time period between any two successive waypoints during the flight exceeds certain threshold. Otherwise, the UE 10 selects the 2-step-RA-SDT.
   d. In another example, the UE 10 selects 2-step-RA-SDT provided that the time period between any two successive waypoints during the flight exceeds certain threshold. Otherwise, the UE 10 selects the 4-step-RA-SDT.
   e. In another example, the UE 10 selects 4-step-RA-SDT provided that the time period between the last waypoint during the flight exceeds certain threshold. Otherwise, the UE 10 selects the 2-step-RA-SDT.
   f. In another example, the UE 10 selects the RA-SDT provided that the time period between any two successive waypoints during the flight exceeds certain threshold. Otherwise, the UE 10 selects the CG-SDT.
   g. In another example, the UE 10 selects the RA-SDT provided that the time period since the last waypoint during the flight exceeds certain threshold. Otherwise, the UE 10 selects the CG-SDT.
In another example of the rule, the UE 10 selects between the RA-SDT and CG-SDT based on the criticality of the UE's flight path characteristics. Different rules may be applied depending on the purpose and scenario, e.g., based on the type of the critical situation. This is explained with several examples below:
   In one example, the UE 10 selects the RA-SDT if the UE 10 is operating in critical state; otherwise, i.e., if the UE 10 is in normal state, the UE 10 selects the CG-SDT.
   In another example, the UE 10 selects the CG-SDT if the UE 10 is operating in critical state; otherwise, i.e., if the UE 10 is in normal state, the UE 10 selects the RA-SDT.
   In another example, the UE 10 selects the 2-step-RA-SDT if the UE 10 is operating in critical state; otherwise, i.e., if the UE 10 is in normal state, the UE 10 selects the 4-step-RA-SDT.
   In another example, the UE 10 selects the 4-step-RA-SDT if the UE 10 is operating in critical state; otherwise, i.e., if the UE 10 is in normal state, the UE 10 selects the 2-step-RA-SDT.
In another example of the rule, the UE 10 selects between the RA-SDT and CG-SDT based on whether the UE 10 has to meet additional SRE requirements during the UAV operation. Different rules may be applied depending on the purpose and scenario, e.g., based on the type of the UE's FPI to be sent via SDT. This is explained with several examples below:
   In one example, the UE 10 selects the CG-SDT if the UE 10 has to meet the SRE requirements; otherwise, the UE 10 selects the RA-SDT.
   In another example, the UE 10 selects the 2-step-RA-SDT if the UE 10 has to meet the SRE requirements; otherwise, i.e., if the UE 10 is in normal state, the UE 10 selects the 4-step-RA-SDT.
   In another example, the UE 10 selects the 4-step-RA-SDT if the UE 10 has to meet the SRE requirements; otherwise, i.e., if the UE 10 is in normal state, the UE 10 selects the 2-step-RA-SDT.

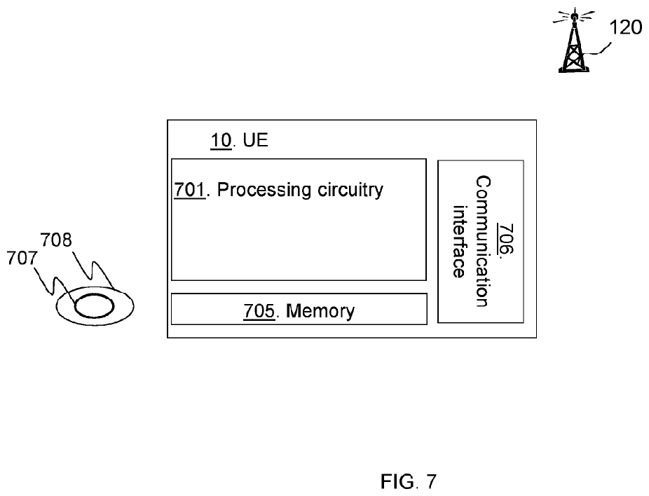

FIG. 7 is a block diagram depicting the UE 10 for handling communication in the wireless communications network 1, such as handling a flight information, in the wireless communications network according to embodiments herein.

The UE 10 may comprise processing circuitry 701, e.g., one or more processors, configured to perform the methods herein.

The UE 10 and/or the processing circuitry 701 is configured to transmit the flight indication to the radio network node using the SDT procedure. The flight indication comprises one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; and/or Indication of update on flight path report or part of it.

The UE 10 and/or the processing circuitry 701 may be configured to be configured by the radio network node 120, to perform the procedure, i.e., transmit the flight indication using SDT. The UE 10 and/or the processing circuitry 701 may be configured to transmit the flight indication when one or more conditions are met, e.g., when the flight path changes with regards to the planned or pre-configured flight path. The one or more conditions may comprise one or more of the following:
if no flight indication has been sent to a same radio network node in previous x seconds;
if a current location of the UE or a next waypoint is within a position interval from a border of a geographical area;
if a velocity and/or a height of the UE exceeds a certain pre-defined or pre-configured velocity and/or height threshold;
when a number of waypoints during a flight or a time period exceeds a threshold; and
based on a timing relation between waypoints.

The UE 10 and/or the processing circuitry 701 may be configured to select a SDT method among a plurality of SDT methods for transmitting the flight indication to the radio network node based on one or more criteria. The one or more criteria may comprise one or more of the following:
based on a criticality of flight path characteristics;
to meet additional radio emission requirements during operation;
based on a timing relation between waypoints during a flight path;
based on a relation between number of waypoints and a threshold;
based on direction of movement of the UE;
based on a mobility state of the UE; and
based on a height and a threshold.

The UE 10 may comprise a memory 705. The memory 705 comprises one or more units to be used to store data on, such as data packets, indications, FPI, flight indications, RRC configurations, one or more conditions, events and applications to perform the methods disclosed herein when being executed, and similar. Furthermore, the UE 10 may comprise a communication interface 706 such as comprising a transmitter, a receiver, a transceiver and/or one or more antennas.

The methods according to the embodiments described herein for the UE 10 are respectively implemented by means of e.g., a computer program product 707 or a computer program, comprising instructions, i.e., software code portions, which, when executed on at least one processor, cause the at least one processor to carry out the actions described herein, as performed by the UE 10. The computer program product 707 may be stored on a computer-readable storage medium 708, e.g., a disc, a Universal Serial Bus (USB) stick or similar. The computer-readable storage medium 708, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium. Thus, embodiments herein may disclose a UE for handling communication in a wireless communications network, wherein the UE comprises processing circuitry and a memory, said memory comprising instructions executable by said processing circuitry whereby said UE is operative to perform any of the methods herein.

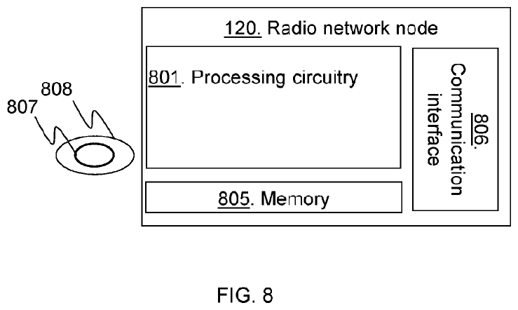

FIG. 8 is a block diagram depicting the radio network node 120 such as the first radio network node 12 or the second radio network node 13, according to embodiments herein for handling communication in the wireless communications network.

The radio network node 120 may comprise processing circuitry 801, e.g., one or more processors, configured to perform the methods herein.

The radio network node 120 and/or the processing circuitry 801 is configured to receive the flight indication from the UE 10, in a low activity RRC state, using a SDT procedure. The flight indication comprises one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it.

The radio network node 120 and/or the processing circuitry 801 may be configured to configure the UE 10, to perform the procedure, i.e., to transmit or report flight indication using the SDT procedure. The radio network node 120 and/or the processing circuitry 801 may be configured to configure the UE 10 to transmit the flight indication when one or more conditions are met, e.g., when the flight path changes with regards to the planned or pre-configured flight path. The one or more conditions may comprise one or more of the following:
if no flight indication has been sent to a same radio network node in previous x seconds;
if a current location of the UE or a next waypoint is within a position interval from a border of a geographical area;
if a velocity and/or a height of the UE exceeds a certain pre-defined or pre-configured velocity and/or height threshold;
when a number of waypoints during a flight or a time period exceeds a threshold; and
based on a timing relation between waypoints.

The radio network node 120 and/or the processing circuitry 801 is configured to perform the action taking the flight indication into account.

The radio network node 120 and/or the processing circuitry 801 may be configured to perform the action by responding to a msg3 if the UE 10 is performing four-step RACH, or in a response message to a MSGA if the UE 10 is performing two-step RACH, whether the radio network node wants the UE 10 to report the flight indication.

The radio network node 120 and/or the processing circuitry 801 may be configured to perform the action by either waiting for a scheduling request from the UE 10 or directly scheduling one or more uplink resources for a flight path report.

The radio network node 120 and/or the processing circuitry 801 may be configured to perform the action by proactively taking one or more measures to ensure that a connectivity is ensured during a flight of the UE 10.

The radio network node 120 and/or the processing circuitry 801 may be configured to perform the action by preparing network resources or mobility management measures to cope with interference and mobility challenges caused by high speed and/or altitude of the UE 10.

The radio network node 120 and/or the processing circuitry 801 may be configured to obtain FPI. The radio network node and/or the processing circuitry 801 may be configured to receive FPI from an operator or similar.

The radio network node 120 may comprise a memory 805. The memory 805 comprises one or more units to be used to store data on, such as data packets, indications, values, FPI, flight indications, bearer information, message type information, one or more conditions, mobility events, measurements, events and applications to perform the methods disclosed herein when being executed, and similar. Furthermore, the radio network node may comprise a communication interface 806 such as comprising a transmitter, a receiver, a transceiver and/or one or more antennas.

The methods according to the embodiments described herein for the radio network node are respectively implemented by means of e.g., a computer program product 807 or a computer program, comprising instructions, i.e., software code portions, which, when executed on at least one processor, cause the at least one processor to carry out the actions described herein, as performed by the radio network node. The computer program product 807 may be stored on a computer-readable storage medium 808, e.g., a disc, a USB stick or similar. The computer-readable storage medium 808, having stored thereon the computer program product, may comprise the instructions which, when executed on at least one processor, cause the at least one processor to carry out the actions described herein, as performed by the radio network node. In some embodiments, the computer-readable storage medium may be a transitory or a non-transitory computer-readable storage medium. Thus, embodiments herein may disclose a radio network node for handling communication in a wireless communications network, wherein the radio network node comprises processing circuitry and a memory, said memory comprising instructions executable by said processing circuitry whereby said radio network node is operative to perform any of the methods herein.

### Terminology

In this disclosure a term node is used which can be a radio network node or a user equipment (UE). The description mentions aerial UE but it could be also air-to-ground (ATG) UE, or Integrated Access and Backhaul (IAB) UE or other user equipment which informs network of its flight path plan.

Examples of radio network nodes are NodeB, Base Station (BS), Multi-Standard Radio (MSR) radio node such as MSR BS, eNodeB, gNodeB, MeNB, SeNB, a network node belonging to Master Cell Group (MCG) or Secondary Cell Group (SCG), Location Measurement Unit (LMU), IAB node, network controller, Radio Network Controller (RNC), Base Station Controller (BSC), relay, donor node controlling relay, Base Transceiver Station (BTS), Central Unit (e.g., in a gNB), Distributed Unit (e.g., in a gNB), Baseband Unit, Centralized Baseband, C-RAN, Access Point (AP), transmission points, transmission nodes, Transmission Reception Point (TRP), Remote Radio Unit (RRU), Remote Radio Head (RRH), nodes in Distributed Antenna System (DAS), core network node (e.g., MSC, MME etc), O&M, OSS, SON, positioning node (e.g., E-SMLC), etc.

The non-limiting term UE refers to any type of wireless device communicating with a network node and/or with another UE in a cellular or mobile communication system. Examples of UE are target device, ATG UE, D2D UE, proximity capable UE (aka ProSe UE), vehicular to vehicular (V2V device, machine type UE, MTC UE or UE capable of machine to machine (M2M) communication, PDA, tablet, mobile terminals, smart phone, laptop embedded equipment (LEE), laptop mounted equipment (LME), USB dongles etc. In some embodiments the non-limiting term ‘aerial UE (AUE)’ is used and it refers to any type of UE equipped or housed or located in any type of flying object. The flying object moves or flies in air or in free space. The term flying object is interchangeably called as flying vehicle, Aerial Vehicle (AV), aerial object, aerial device, IAB node, ATG UE etc. Examples of the flying object are aircraft, drone, chopper, helicopter, flying balloon, glider, flying bus etc. In some embodiments AV may also refer to Aerial UE (AUE).

The term radio access technology (RAT) may refer to any RAT, e.g., Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), UTRA, E-UTRA, narrow band internet of things (NB-IoT), WiFi, Bluetooth, next generation RAT, New Radio (NR), 4G, 5G, etc. Any of the equipment denoted by the term node, network node or radio network node may be capable of supporting a single or multiple RATs.

The term signal or radio signal used herein can be any physical signal or physical channel. Examples of DL physical signals are Reference Signal (RS) such as PSS, SSS, CSI-RS, DMRS signals in SS/PBCH block (SSB), Discovery Reference Signal (DRS), CRS, PRS etc. RS may be periodic e.g., RS occasion carrying one or more RSs may occur with certain periodicity e.g., 20 ms, 40 ms etc. The RS may also be aperiodic. Each SSB carries NR-PSS, NR-SSS and NR-PBCH in 4 successive symbols. One or multiple SSBs are transmitted in one SSB burst which is repeated with certain periodicity e.g., 5 ms, 10 ms, 20 ms, 40 ms, 80 ms and 160 ms. The UE is configured with information about SSB on cells of certain carrier frequency by one or more SS/PBCH block Measurement Timing Configuration (SMTC). The SMTC configuration comprisES parameters such as SMTC periodicity, SMTC occasion length in time or duration, SMTC time offset with respect to reference time e.g., serving cell's SFN etc. Therefore, SMTC occasion may also occur with certain periodicity e.g., 5 ms, 10 ms, 20 ms, 40 ms, 80 ms and 160 ms. Examples of UL physical signals are reference signal such as SRS, DMRS etc. The term physical channel refers to any channel carrying a higher layer information e.g., data, control etc. Examples of physical channels are PBCH, NPBCH, PDCCH, PDSCH, sPUCCH, SPDSCH. sPUCCH. sPUSCH, MPDCCH, NPDCCH, NPDSCH, E-PDCCH, PUSCH, PUCCH, NPUSCH etc.

The term time resource used herein may correspond to any type of physical resource or radio resource expressed in terms of length of time. Examples of time resources are: symbol, time slot, subframe, radio frame, Transmission Time Interval (TTI), interleaving time, slot, sub-slot, mini-slot, System Frame Number (SFN) cycle, hyper-SFN (H-SFN) cycle etc.

Thus, in some embodiments a more general term “radio network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), S-DU, C-DU or a CU, etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single Application-Specific Integrated Circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, Digital Signal Processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as Read-Only Memory (ROM), Random-Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

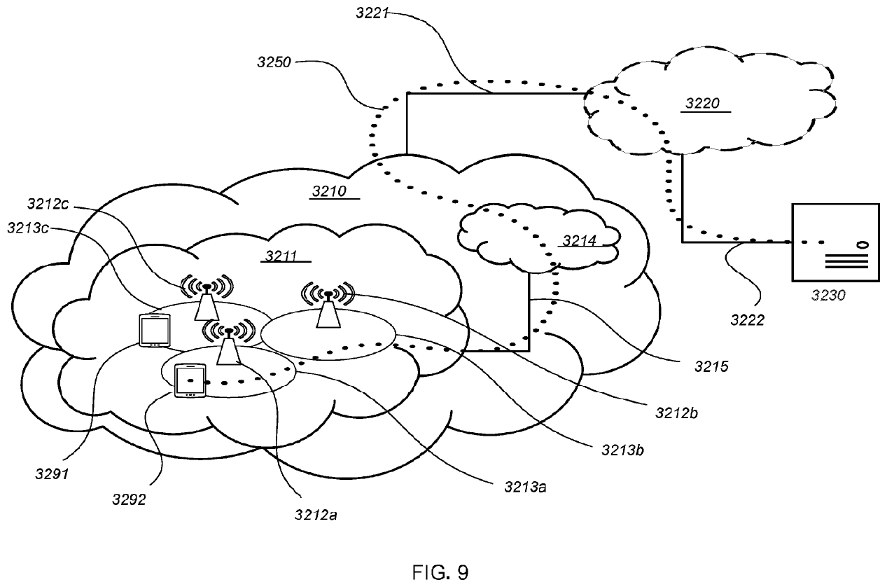

With reference to FIG. 9, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12,13 herein, each defining a corresponding coverage area 3213a, 3213b, 3213c. Each base station 3212a, 3212b, 3212c is connectable to the core network 3214 over a wired or wireless connection 3215. A first UE 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 9 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signalling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

In some embodiments, the telecommunication network 3210 includes one or more Open-RAN (ORAN) network nodes. An ORAN network node is a node in the telecommunication network 3210 that supports an ORAN specification (e.g., a specification published by the O-RAN Alliance, or any similar organization) and may operate alone or together with other nodes to implement one or more functionalities of any node in the telecommunication network 3210, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes facilitate direct or indirect connection of user equipment (UE), such as by connecting UEs (one or more of which may be generally referred to as UEs 3291, 3292) to the core network over one or more wireless connections.

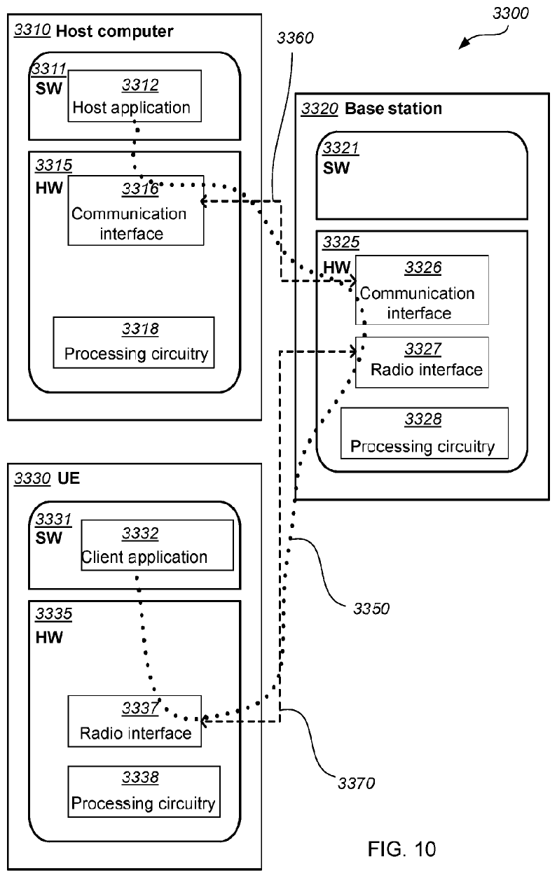

Example implementations, in accordance with an embodiment, of the UE, base station and host computer discussed in the preceding paragraphs will now be described with reference to FIG. 10. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 10) served by the base station 3320. The communication interface 3326 may be configured to facilitate a connection 3360 to the host computer 3310. The connection 3360 may be direct or it may pass through a core network (not shown in FIG. 10) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 10 may be identical to the host computer 3230, one of the base stations 3212a, 3212b, 3212c and one of the UEs 3291, 3292 of FIG. 9, respectively. This is to say, the inner workings of these entities may be as shown in FIG. 10 and independently, the surrounding network topology may be that of FIG. 9.

In FIG. 10, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since the radio network node has more information about the flight path, and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

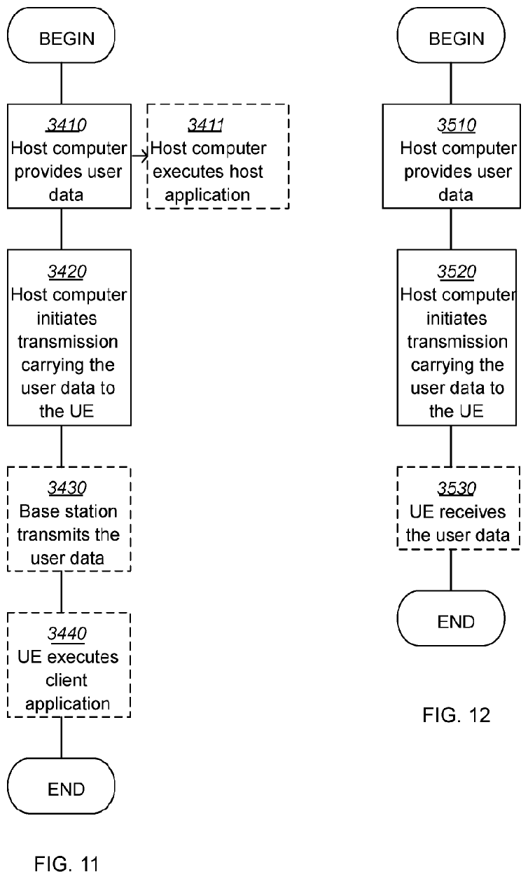

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

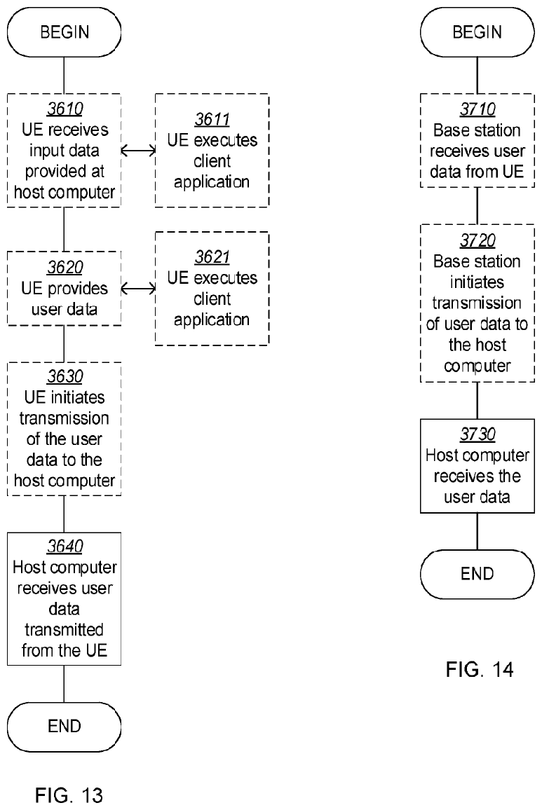

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

Modifications and other embodiments of the disclosed embodiments will come to mind to one skilled in the art having the benefit of the teachings presented in the foregoing descriptions and the associated drawings. Therefore, it is to be understood that the embodiment(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

### EMBODIMENTS

### Embodiment A1

A method performed by a UE for handling communication in a wireless communications network, the method comprising
transmitting a flight indication to a radio network node using an SDT procedure, wherein the flight indication comprises flight path information, FPI, that comprises one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it, wherein the indication indicates a flight path.

### Embodiment B1

A method performed by a radio network node for handling communication in a wireless communications network, the method comprising
receiving a flight indication from a UE using a SDT procedure, wherein the flight indication comprises FPI, that comprises one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it; and
performing an action taking the flight indication into account.

### Embodiment C1

A UE for handling communication in a wireless communications network, wherein the UE is configured to transmit a flight indication to a radio network node using an SDT procedure, wherein the flight indication comprises flight path information, FPI, that comprises one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it, wherein the indication indicates a flight path.

### Embodiment D1

A radio network node for handling communication in a wireless communications network, wherein the radio network node is configured to receive a flight indication from a UE using a SDT procedure, wherein the flight indication comprises FPI, that comprises one or more of the following: Flight path report, or part of flight path report; Update to flight path report, or element of the flight path report. For example, if flight path report consists of waypoints and time stamp, the element may be one of these or one coordinate used in waypoint expression; Indication of availability of flight path report; Indication of update on flight path report or part of it; and to perform an action taking the flight indication into account.

### Abbreviation Explanation

AD Aerial device
ATG Air-to-ground
AUE Aerial UE
AV Aerial vehicle
BLER Block error rate
BWP Bandwidth part
CP Cyclic prefix
CSI-RS Channel state information reference signals
CSSF Carrier-specific scaling factor
DCI Downlink control information
DL Downlink
eMBB Evolved mobile broadband
FDD Frequency division duplex
FOM Flight operational mode
FR1 Frequency range 1
FR2 Frequency range 2
FR3 Frequency range 3
gNB Next generation Node B (5G base station)
HARQ Hybrid automatic repeate request
MAC Medium access control
MBB Mobile Broadband
MDT Minimization of drive test
MGL Measurement gap length
MGO Measurement gap offset
MGP Measurement gap pattern
MGRP Measurement gap repetition period
MGTA Measurement gap timing advance
MM Measurement mode
NACK Negative acknowledgement
NR New radio (5G)
PBCH Physical broadcast channel
PCell Primary Cell
PCC Primary component carrier
PDCCH Physical downlink control channel
PDSCH Physical downlink shared channel
PRS Positioning reference signals
PSC Primary secondary carrier
PSCell Primary secondary cell
PUCCH Physical uplink control channel
PUSCH Physical uplink shared channel
RAT Radio access technology
RRC Radio resource control
RRM Radio resource management
SCS Subcarrier spacing
SFN System frame number
SMTC SSB measurement timing configuration
SON Self-Organizing Network
SpCell Special cell
SRS Sounding reference signal
SSB Synchronization signal and PBCH block
TDD Time division duplex
UAS Unmanned Aircraft Systems
UAV Unmanned Aerial Vehicles
UE User equipment
UTM Unmanned Aircraft Systems Traffic Management
UL Uplink

1.-30. (canceled)

31. A method performed by a user equipment (UE) for handling communication in a wireless communications network, the method comprising:
transmitting, in a low activity radio resource control (RRC) state, a flight indication to a radio network node using a small data transmission (SDT) procedure, wherein the flight indication comprises one or more of the following:
at least a part of a flight path report;
an update to a flight path report, or an element of the flight path report;
an indication of availability of flight path report; and
an indication of update on flight path report or part of it.

32. The method according to claim 31, comprising:
configuring, by the radio network node, the UE to transmit the flight indication using the SDT procedure.

33. The method according to claim 31, wherein transmitting the flight indication is performed when one or more conditions are met.

34. The method according to claim 33, wherein the one or more conditions comprise one or more of the following:
if no flight indication has been sent to a same radio network node in previous x seconds;
if a current location of the UE or a next waypoint is within a position interval from a border of a geographical area;
if a velocity and/or a height of the UE exceeds a certain pre-defined or pre-configured velocity and/or height threshold;
when a number of waypoints during a flight or a time period exceeds a threshold; and
based on a timing relation between waypoints.

35. The method according to claim 31, further comprising:
selecting a SDT method among a plurality of SDT methods for transmitting the flight indication to the radio network node based on one or more criteria.

36. The method according to claim 35, wherein the one or more criteria comprise one or more of the following:
based on a criticality of flight path characteristics;
to meet additional radio emission requirements during operation;
based on a timing relation between waypoints during a flight path;
based on a relation between number of waypoints and a threshold;
based on direction of movement of the UE;
based on a mobility state of the UE; and
based on a height and a threshold.

37. A method performed by a radio network node for handling communication in a wireless communications network, the method comprising:
receiving a flight indication from a user equipment (UE), in a low activity radio resource control (RRC) state, using a small data transmission (SDT) procedure, wherein the flight indication comprises one or more of the following:
at least a part of a flight path report;
an update to a flight path report, or an element of the flight path report;
an indication of availability of flight path report; and
an indication of update on flight path report or part of it; and
performing an action taking the flight indication into account.

38. The method according to claim 37, comprising:
configuring the UE to transmit the flight indication using the SDT procedure.

39. The method according to claim 38, wherein configuring the UE comprises configuring the UE to transmit the flight indication when one or more conditions are met.

40. The method according to claim 39, wherein the one or more conditions comprise one or more of the following:
if no flight indication has been sent to a same radio network node in previous x seconds;
if a current location of the UE or a next waypoint is within a position interval from a border of a geographical area;
if a velocity and/or a height of the UE exceeds a certain pre-defined or pre-configured velocity and/or height threshold;
when a number of waypoints during a flight or a time period exceeds a threshold; and
based on a timing relation between waypoints.

41. The method according to claim 37, wherein performing the action comprises responding to a msg3 if the UE is performing 4-step random access channel (RACH) or in a response message to MSGA if the UE is performing 2-step RACH, whether the radio network node wants the UE to report the flight indication.

42. The method according to claim 37, wherein performing the action comprises either waiting for a scheduling request from the UE or directly scheduling one or more uplink resources for a flight path report.

43. The method according to claim 37, wherein performing the action comprises proactively taking one or more measures to ensure that a connectivity is ensured during a flight of the UE.

44. The method according to claim 37, wherein performing the action comprises preparing network resources or mobility management measures to cope with interference and mobility challenges caused by high speed and/or altitude of the UE.

45. A user equipment (UE) for handling communication in a wireless communications network, wherein the UE comprises:
processing circuitry configured to transmit, in a low activity radio resource control (RRC) state, a flight indication to a radio network node using a small data transmission (SDT) procedure, wherein the flight indication comprises one or more of the following:
at least a part of a flight path report;
an update to a flight path report, or an element of the flight path report;
an indication of availability of flight path report; and
an indication of update on flight path report or part of it.

46. The UE according to claim 45, wherein the UE is configured, by the radio network node, to transmit the flight indication using the SDT procedure.

47. The UE according to claim 45, wherein the processing circuitry is configured to transmit the flight indication when one or more conditions are met.

48. The UE according to claim 47, wherein the one or more conditions comprise one or more of the following:
if no flight indication has been sent to a same radio network node in previous x seconds;
if a current location of the UE or a next waypoint is within a position interval from a border of a geographical area;
if a velocity and/or a height of the UE exceeds a certain pre-defined or pre-configured velocity and/or height threshold;
when a number of waypoints during a flight or a time period exceeds a threshold; and
based on a timing relation between waypoints.

49. The UE according to claim 45, wherein the processing circuitry is configured to:
select a SDT method among a plurality of SDT methods for transmitting the flight indication to the radio network node based on one or more criteria.

50. A radio network node for handling communication in a wireless communications network, wherein the radio network node comprises:
processing circuitry configured to receive a flight indication from a user equipment (UE) in a low activity radio resource control (RRC) state, using small data transmission (SDT) procedure, wherein the flight indication comprises one or more of the following:
at least a part of a flight path report;
an update to a flight path report, or an element of the flight path report;
an indication of availability of flight path report; and
an indication of update on flight path report or part of it; and
perform an action taking the flight indication into account.
